(19) United States
(12) Patent Application Publication
(10) Pub. No.: US 2008/0307037 A1
(43) Pub. Date: Dec. 11, 2008

(54) Client Notification Mechanism Over HTTP

(75) Inventors: Kai Zhang, Sunnyvale, CA (US); Linlong Jiang, Sunnyvale, CA (US)

Correspondence Address: MPG, LLP AND YAHOO! INC., 710 LAKEWAY DRIVE, SUITE 200, SUNNYVALE, CA, 94085, US

(73) Assignee: Yahoo! Inc., Sunnyvale, CA (US)

(21) Appl. No.: 11/759,895

(22) Filed: Jun. 7, 2007

(51) Int. Cl. G06F 15/16

(52) U.S. Cl. 709/203

(57) ABSTRACT

A TCP connection is opened between a client and a server. An HTTP client request is transmitted from the client to the server over the open TCP connection. If client data is not pending at the server upon receipt of the HTTP client request at the server, the server waits for client data to become available before sending a server response to the client, thereby maintaining the open TCP connection. However, if client data is pending at the server upon receipt of the HTTP client request at the server, a server response including the client data is transmitted from the server to the client over the open TCP connection. Promptly upon receiving the server response, the client transmits a new HTTP client request to the server, thereby ensuring that an open TCP connection is maintained between the client and the server.

### BACKGROUND OF THE INVENTION

Many internet applications are implemented using client-server communication via the well-known transmission control protocol over internet protocol (TCP/IP) or user datagram protocol over internet protocol (UDP/IP). However, with the deployment of client-side firewalls, communication between a server and the client may be restricted. A firewall may allow client-server communication using the well-known hypertext transfer protocol (HTTP or HTTPS) for communication, while blocking non-HTTP/HTTPS client-server communication. For example, the firewall may allow normal HTTP communication between the client and server, but may prevent the client from establishing a long-lived persistent TCP connection to the server.

HTTP uses a request-response communication model. Therefore, HTTP does not serve well when a server needs to “push” data to a client, i.e., when a server needs to send unsolicited data to a client. However, with many applications, such as instant messenger (IM), the server needs to be able to send unsolicited data, e.g., a notification event, to the client.

Existing solutions for enabling the server to send unsolicited data to the client require the client to poll the server periodically in order to check if there is any data that needs to be sent to the client. Upon receiving a poll, e.g., request, from the client, the server is able to send a response to the client. It should be appreciated that in the HTTP request-response model, the server immediately replies to the client request, even if there is no data available to be sent to the client. Consequently, when there is no data available to be sent to the client, the polling by the client and the corresponding empty response by the server amounts to wasted communication and associated overhead.

Therefore, the client polling approach using the HTTP request-response model has two significant shortcomings. First, the polling by the client in the absence of data at the server consumes processor cycles on both the client and the server without a corresponding productive communication of data. Second, when data becomes available at the server for transmission to the client, the server will have to wait for the next polling by the client to deliver the data to the client. Therefore, depending on the polling frequency, the data may not be delivered to the client in a timely manner.

### SUMMARY OF THE INVENTION

In one embodiment, a method is disclosed for communicating between a client and a server. The method includes an operation for opening a transmission control protocol (TCP) connection between the client and the server. A hypertext transfer protocol (HTTP) client request is then transmitted from the client to the server over the open TCP connection. Upon receipt of the HTTP client request at the server, a determination is made as to whether client data is pending at the server. Upon determining that client data is pending at the server, a server response including the client data is transmitted from the server to the client over the open TCP connection. Then, promptly upon receiving the server response at the client, the client transmits a new HTTP client request to the server. Upon determining that client data is not pending at the server, the server waits for client data to become available before sending a server response to the client, thereby maintaining the open TCP connection.

In another embodiment, a system for controlling communication between a client and a server is disclosed. The system includes a client communication module and a server communication module. The client communication module is defined to open a TCP connection with the server communication module, and transmit a HTTP client request to the server communication module over the open TCP connection. The server communication module is defined to wait for client data to become available at the server communication module before sending a server response to the client communication module, thereby maintaining the open TCP connection.

In another embodiment, a computer readable medium having program instructions stored thereon for controlling server side communication with a client is disclosed. On the computer readable medium, program instructions are included for opening a TCP connection with a client. Program instructions are also included for receiving a HTTP client request from the client over the open TCP connection. Further program instructions are included for delaying a server response to the HTTP client request until client data becomes available for transmission to the client so as to maintain the open TCP connection. Program instructions are also included for transmitting a server response to the client over the open TCP connection when client data is pending for transmission to the client. Additionally, program instructions are included for receiving a subsequent HTTP client request from the client promptly upon the client's receipt of the server response so as to maintain an open TCP connection with the client.

In another embodiment, a method is disclosed for communicating between a client and a server. The method includes an operation for opening a TCP connection between a client and a server. An operation is then performed to transmit a HTTP client request from the client to the server over the open TCP connection. If client data is not pending at the server upon receipt of the HTTP client request at the server, the server is operated to wait for client data to become available before sending a server response to the client, thereby maintaining the open TCP connection. However, if client data is pending at the server upon receipt of the HTTP client request at the server, the server is operated to transmit a server response including the client data from the server to the client over the open TCP connection. The server response is tagged with a server response sequence number. Promptly upon receiving the server response at the client, the client is operated to transmit a new HTTP client request from the client to the server. The new HTTP client request includes the server response sequence number tagged to the server response most recently received by the client. Then, upon receiving the new HTTP client request at the server, the server is operated to verify that the server response sequence number included with the new HTTP client request matches the server response sequence number tagged to the most recently transmitted server response. If the server response sequence number included with the new HTTP client request does not match the server response sequence number tagged to the most recently transmitted server response, the server is operated to retransmit the most recently transmitted server response to the client.

Other aspects and advantages of the invention will become more apparent from the following detailed description, taken in conjunction with the accompanying drawings, illustrating by way of example the present invention.

### BRIEF DESCRIPTION OF THE DRAWINGS

FIG. 1 is an illustration showing a communication architecture, in accordance with one embodiment of the present invention;

FIG. 2A is an illustration showing a flowchart of a method for communicating between a client and a server, in accordance with one embodiment of the present invention; and

FIG. 2B is an illustration showing a flowchart of a method for communicating between a client and a server with incorporation of a server response sequence number check, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

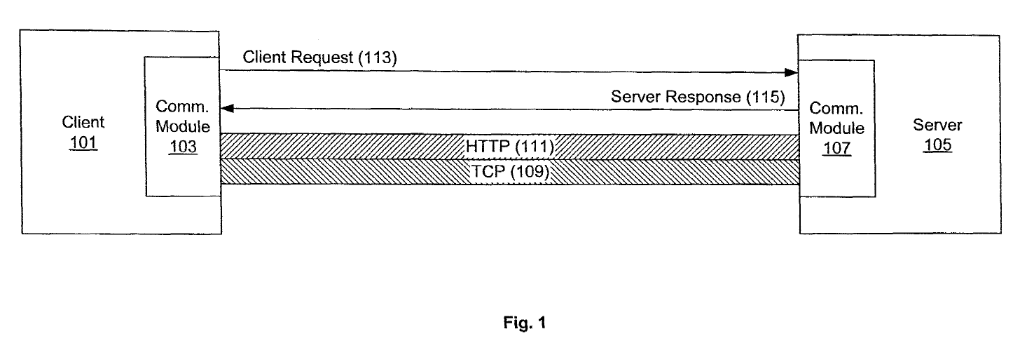

FIG. 1 is an illustration showing a communication architecture, in accordance with one embodiment of the present invention. The communication architecture includes a client 101 and a server 105. Each of the client 101 and the server 105 represents a computing system that includes at least a processor and a memory. The client 101 includes a communication module 103 defined to perform the client-side operations necessary to enable communication with the server 105. Similarly, the server 105 includes a communication module 107 defined to perform the server-side operations necessary to enable communication with the client 101. In one embodiment, the client and server communication modules 103/107 are defined to establish a transmission control protocol (TCP) connection 109 between the client 101 and the server 105. In one embodiment, the TCP connection 109 is a transient TCP connection in which one pair of HTTP request and response messages is communicated over a TCP connection establishment/shutdown. In another embodiment, the TCP connection 109 is a persistent TCP connection in which multiple pairs of HTTP request and response messages are communicated over a TCP connection establishment/shutdown.

The client and server communication modules 103/107 are further defined to enable communication between the client 101 and the server 105 using a hypertext transfer protocol (HTTP) 111 over the TCP connection 109. As HTTP is a request-response protocol, the HTTP 111 communication between the client 101 and server 105 includes transmission of a client request 113 to the server 105, with a corresponding transmission of a server response 115 to the client 101. It should be understood that the server response 115 is the mechanism by which the server 105 is capable of communicating with the client 101. Therefore, the server 105 needs to receive a client request 113 in order to communicate data to the client 101 via the server response 115.

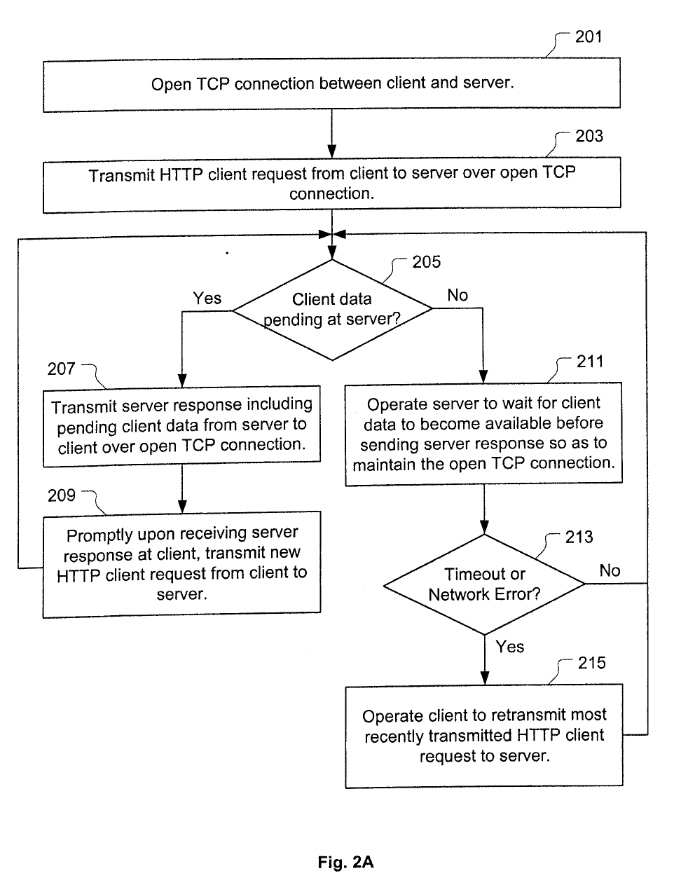

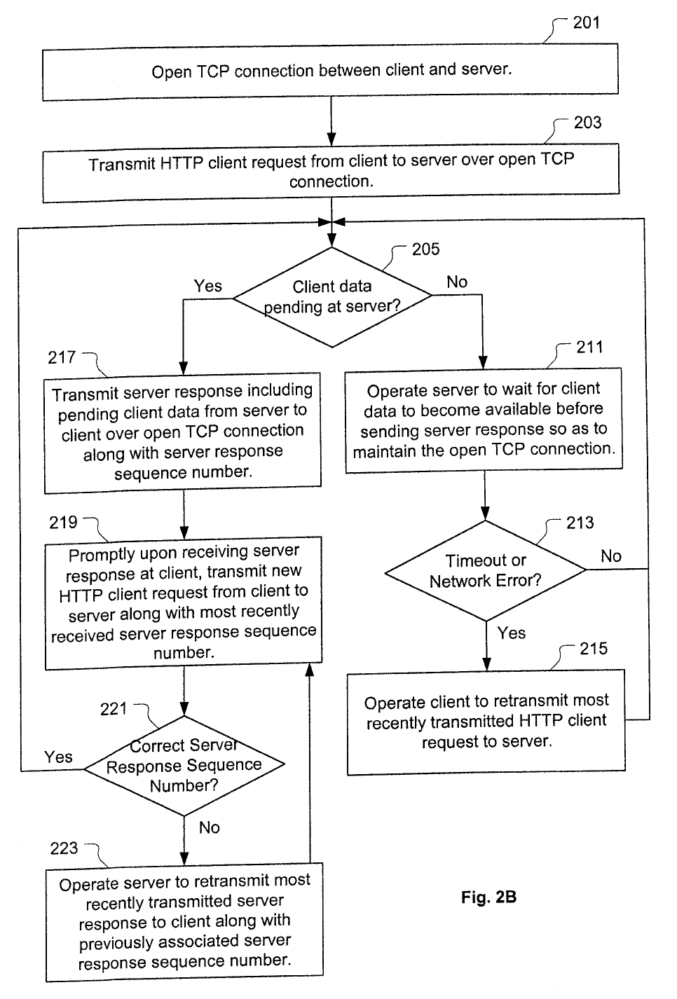

FIG. 2A is an illustration showing a flowchart of a method for communicating between a client and a server, in accordance with one embodiment of the present invention. It should be understood that the client-server communication described with regard to FIG. 2A can be conducted over essentially any type of computing network that enables client-server communication. For example, in various embodiments, the client-server communication can be conducted over a wired network, a wireless network, or a combination thereof. For descriptive purposes, the method of FIG. 2A is described within the context of the communication architecture of FIG. 1.

With regard to the method of FIG. 2A, an operation 201 is performed in which the TCP connection 109 is opened between the client 101 and the server 105 over a network linking the client 101 and the server 105. In one embodiment, the TCP connection 109 opened in operation 201 is a transient TCP connection. However, in other embodiments, the TCP connection 109 opened in operation 201 is a persistent TCP connection. Additionally, in one embodiment, the TCP connection 109 opened in operation 201 is established through a firewall present at the client 101, wherein the firewall is defined to block unsolicited communications from outside servers.

From the operation 201, the method proceeds with an operation 203 for transmitting a HTTP client request 113 from the client 101 to the server 105 over the open TCP connection 109. The transmitted HTTP client request 113 is defined to direct the server 105 to send any pending client data to the client 101. Upon receipt of the HTTP client request 113 at the server 105, a decision operation 205 is performed to determine if client data is pending at the server 105 for transmission to the client 101. If client data is pending at the server 105 upon receipt of the HTTP client request 113, an operation 207 is performed to transmit a server response 115 including the client data from the server 105 to the client 101 over the open TCP connection 109. Then, promptly and automatically upon receiving the server response 115 at the client 101, an operation 209 is performed to transmit a new HTTP client request 113 from the client 101 to the server 105. From operation 209, the method reverts back to the decision operation 205 for determining if client data is pending at the server 105.

In one embodiment, upon receiving the server response 115 at the client 101, the client 101 is operated to maintain the open TCP connection 109 and use the open TCP connection 109 to transmit the new HTTP client request 113 from the client 101 to the server 105. In another embodiment, upon receiving the server response 115 at the client 101, the client 101 is operated to close the open TCP connection 109, open a new TCP connection 109 between the client 101 and the server 105, and use the newly opened TCP connection 109 to transmit the new HTTP client request 113 from the client 101 to the server 105.

Referring back to operation 205, if client data is not pending at the server 105 upon receipt of the HTTP client request 113 at the server 105, an operation 211 is performed in which the server 105 is operated to wait for client data to become available before sending a server response 115 to the client 101, thereby maintaining the open TCP connection 109. It should be appreciated that operation 211 differs from the conventional HTTP request-response communication method which requires that server 105 immediately transmit a server response to the client 101 upon receipt of each client request regardless of whether or not client data is pending at the server 105.

While the server 105 is waiting for client data to become available, thereby holding open the TCP connection 109, it is possible that the TCP connection 109 will experience a timeout or network error condition. For example, the network error condition may be caused by a number of different occurrences, such as a router reboot or a connection reset, among others. Therefore, from the operation 211, the method includes a decision operation 213 to determine if a timeout or network error condition exists for the open TCP connection 109. If a timeout or network error condition does not exist, the method reverts back to the decision operation 205 for determining if client data is pending at the server 105. Thus, if a timeout or network error condition has not occurred, the server 105 continues to wait for client data to become available before sending the server response 115 to the client 101 over the open TCP connection 109. If a timeout or network error condition does exist at operation 213, the method proceeds with an operation 215 in which the client 101 is operated to retransmit the most recently transmitted HTTP client request 113 to the server 105. From operation 215, the method reverts back to the decision operation 205 for determining if client data is pending at the server 105. The method of FIG. 2A continues until either the client 101 or the server 105 terminates the communication session. It should be appreciated that the method of FIG. 2A ensures that an open TCP connection 109 is maintained between the client 101 and the server 105 so as to enable the server 105 to push data to the client 101 using HTTP over TCP.

FIG. 2B is an illustration showing a flowchart of a method for communicating between a client and a server with incorporation of a server response sequence number check, in accordance with one embodiment of the present invention. The method of FIG. 2B is essentially an extension of the method of FIG. 2A. The methods of FIGS. 2A and 2B share the same operations 201, 203, 205, 211, 213, and 215. Therefore, the method of FIG. 2B includes the operation 201 for opening the TCP connection 109 between the client 101 and the server 105. The method then proceeds with the operation 203 for transmitting a HTTP client request 113 from the client 101 to the server 105 over the open TCP connection 109. Then, upon receipt of the HTTP client request 113 at the server 105, the decision operation 205 is performed to determine if client data is pending at the server 105 for transmission to the client 101. If client data is not pending at the server 105 upon receipt of the HTTP client request 113 at the server 105, the operation 211 is performed in which the server 105 is operated to wait for client data to become available before sending a server response 115 to the client 101, thereby maintaining the open TCP connection 109.

The method of FIG. 2B includes the decision operation 213 to determine if a timeout or network error condition exists for the open TCP connection 109. If a timeout or network error condition does not exist, the method reverts back to the decision operation 205 for determining if client data is pending at the server 105. Thus, if a timeout or network error condition has not occurred, the server 105 continues to wait for client data to become available before sending the server response 115 to the client 101 over the open TCP connection 109. If a timeout or network error condition does exist at operation 213, the method proceeds with an operation 215 in which the client 101 is operated to retransmit the most recently transmitted HTTP client request 113 to the server 105. From operation 215, the method reverts back to the decision operation 205 for determining if client data is pending at the server 105.

Referring back to the decision operation 205 in the method of FIG. 2B, if client data is pending at the server 105 upon receipt of the HTTP client request 113, an operation 217 is performed to transmit a server response 115 including the client data from the server 105 to the client 101 over the open TCP connection 109. Also, in operation 217, the server 105 is operated to tag each server response 115 transmitted to the client 101 with a server response sequence number. The server response sequence number is defined such that each server response 115 transmitted from the server 105 to the client 101 in a given communication session is sequentially numbered. Additionally, the server 105 maintains a copy of the most recently transmitted server response 115 and corresponding server response sequence number.

Promptly and automatically upon receiving the server response 115 at the client 101, an operation 219 is performed to transmit a new HTTP client request 113 from the client 101 to the server 105. Also, in operation 219, the client 101 is operated to include with each new HTTP client request 113 the server response sequence number tagged to the server response 115 most recently received by the client 101.

Upon receiving the new HTTP client request 113 at the server 105, the server 105 is operated to verify that the server response sequence number included with the new HTTP client request 113 matches the server response sequence number tagged to the most recently transmitted server response 115. Therefore, from the operation 219, the method proceeds with a decision operation 221 for verifying that the server response sequence number received in the new HTTP client request 113 is the correct server response sequence number. If the server response sequence number received in the new HTTP client request 113 is correct, the method reverts back to operation 205 for determining if client data is pending at the server 105.

If the server response sequence number received in the new HTTP client request 113 does not match the server response sequence number tagged to the most recently transmitted server response 115, the method proceeds with an operation 223 in which the server 105 is operated to retransmit the most recently transmitted server response 115 to the client 101. From operation 223, the method reverts back to operation 219 for transmitting a new HTTP client request 113 from the client 101 to the server 105, along with the server response sequence number tagged to the server response 115 most recently received by the client 101. The method of FIG. 2B continues until either the client 101 or the server 105 terminates the communication session. It should be appreciated that the method of FIG. 2B ensures that an open TCP connection 109 is maintained between the client 101 and the server 105 so as to enable the server 105 to push data to the client 101 using HTTP over TCP, while also ensuring that each server response 115 is safely received by the client 101.

It should be appreciated that the server response sequence number generation and verification, as implemented in operations 217, 219, 221, and 223 of the method of FIG. 2B, provides reliability in a server-to-client notification process. For example, it is not uncommon for an HTTP response to be lost due to a network error. However, the network error may not be detected at the time that the server sends the response to the client. In the method of FIG. 2B, the server relies upon the acknowledged server response sequence number to determine whether the client has received the last message.

The communication methods of FIGS. 2A and 2B provide an effective client notification mechanism when using a request-response based communication protocol, such as HTTP or HTTPS. Specifically, in accordance with the communication methods of FIGS. 2A and 2B, it should be appreciated that one client request 113 will always be pending at the server 105, thereby providing the server 105 with an open connection to the client 101 that can be used to push data to the client 101. Thus, the request-response communication methods of FIGS. 2A and 2B enable the server 105 to push data to the client 101 that implements a firewall.

It should be appreciated that the communication methods of FIGS. 2A and 2B hold the client request 113 at the server 105 until data is available to send to the client 101, whereas the conventional request-response method immediately sends a server response 115 to the client 101 even if there is no data ready to send to the client 101. Also, in the methods of FIGS. 2A and 2B, the client 101 automatically sends the new client request 113 to the server 105 upon receipt of the server response 115, whereas the conventional method requires the client 101 to periodically poll the server 105 on an established schedule. Therefore, in the communication methods of FIGS. 2A and 2B, if there is new client data, e.g., notification data, coming up at the server 105, the server 105 can deliver it to the client 101 right away without having to wait for a poll from the client 101, as there is already an outstanding open connection 109 previously initiated by the client 101.

The server 105 is defined to concurrently manage many open connections. Specifically, the server 105 is defined with a capability to simultaneously wait on events from multiple connections using event application programming interfaces (APIs), such as select( ), poll( ), and kevent( ). Additionally, the server 105 can optionally support HTTP keep-alive, such that the server 105 keeps the TCP connection 109 open after sending the server response 115 to the client 101. Support of the HTTP keep-alive feature by the server 105 further improves communication performance, as the client 101 needs to promptly and automatically transmit a new HTTP client request 113 to the server 105 upon receipt of the server response 115.

The communication methods of FIGS. 2A and 2B provide a number of advantages over the conventional request-response communication model. For example, by enabling an effective push capability, the communication methods of FIGS. 2A and 2B increase the usefulness of existing communication software that utilizes HTTP over TCP. The communication methods of FIGS. 2A and 2B facilitate immediate client notification, without having to wait for a scheduled client poll of the server, thereby providing an enhanced user experience. The communication methods of FIGS. 2A and 2B reduce hardware and operation costs by eliminating polling of the server by the client, thereby essentially eliminating wasted processor cycles on both the client and the server when client data is not pending at the server. Furthermore, the communication method of FIG. 2B improves the reliability of message delivery from the server to the client, thereby further improving the user experience.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. The computer readable medium may also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for communicating between a client and a server, comprising:
opening a transmission control protocol (TCP) connection between a client and a server;
transmitting a hypertext transfer protocol (HTTP) client request from the client to the server over the open TCP connection;
determining whether client data is pending at the server upon receipt of the HTTP client request at the server;
upon determining that client data is pending at the server, transmitting a server response including the client data from the server to the client over the open TCP connection, and promptly upon receiving the server response at the client, transmitting a new HTTP client request from the client to the server; and
upon determining that client data is not pending at the server, operating the server to wait for client data to become available before sending a server response to the client so as to maintain the open TCP connection.

2. A method for communicating between a client and a server as recited in claim 1, wherein the TCP connection is a transient TCP connection.

3. A method for communicating between a client and a server as recited in claim 1, wherein each of the HTTP client request and the new HTTP client request is defined to direct the server to send any pending client data to the client.

4. A method for communicating between a client and a server as recited in claim 1, wherein the method ensures that an open TCP connection is maintained between the client and the server to enable the server to push data to the client using HTTP over TCP.

5. A method for communicating between a client and a server as recited in claim 1, further comprising:
operating the server to tag each server response transmitted to the client with a server response sequence number;
operating the client to include with each new HTTP client request the server response sequence number tagged to the server response most recently received by the client; and
upon receiving the new HTTP client request at the server, operating the server to verify that the server response sequence number included with the new HTTP client request matches the server response sequence number tagged to the most recently transmitted server response.

6. A method for communicating between a client and a server as recited in claim 5, further comprising:
if the server response sequence number included with the new HTTP client request does not match the server response sequence number tagged to the most recently transmitted server response, operating the server to retransmit the most recently transmitted server response to the client.

7. A method for communicating between a client and a server as recited in claim 1, further comprising:
upon receiving the server response at the client, maintaining the open TCP connection and using the open TCP connection to transmit the new HTTP client request from the client to the server.

8. A method for communicating between a client and a server as recited in claim 1, further comprising:
upon receiving the server response at the client, closing the open TCP connection, opening a new TCP connection between the client and the server, and using the newly opened TCP connection to transmit the new HTTP client request from the client to the server.

9. A method for communicating between a client and a server as recited in claim 1, further comprising:
detecting either a timeout condition or a network error condition for the open TCP connection; and
upon detecting either the timeout condition or the network error condition, operating the client to retransmit the most recently transmitted HTTP client request to the server.

10. A system for controlling communication between a client and a server, comprising:
a client communication module; and
a server communication module,
wherein the client communication module is defined to open a transmission control protocol (TCP) connection with the server communication module, and transmit a hypertext transfer protocol (HTTP) client request to the server communication module over the open TCP connection, and
wherein the server communication module is defined to wait for client data to become available at the server communication module before sending a server response to the client communication module so as to maintain the open TCP connection.

11. A system for controlling communication between a client and a server as recited in claim 10, wherein the server communication module is defined to transmit a server response to the client communication module over the open TCP connection when client data is available at the server communication module.

12. A system for controlling communication between a client and a server as recited in claim 11, wherein the client communication module is defined to transmit a new HTTP client request to the server communication module promptly upon receiving the server response.

13. A system for controlling communication between a client and a server as recited in claim 12, wherein the server communication module is defined to tag each server response with a server response sequence number, and the client communication module is defined to include with each new HTTP client request the most recently received server response sequence number.

14. A system for controlling communication between a client and a server as recited in claim 13, wherein the server communication module is defined to verify that the server response sequence number included with the new HTTP client request matches the server response sequence number tagged to the most recently transmitted server response.

15. A system for controlling communication between a client and a server as recited in claim 14, wherein the server communication module is defined to retransmit the most recently transmitted server response to the client communication module upon identifying that server response sequence number included with the new HTTP client request does not match the server response sequence number tagged to the most recently transmitted server response.

16. A system for controlling communication between a client and a server as recited in claim 10, wherein the client communication module is defined to retransmit the most recently transmitted HTTP client request to the server communication module upon detecting either a timeout condition or a network error condition for the open TCP connection.

17. A computer readable medium having program instructions stored thereon for controlling server side communication with a client, comprising:
program instructions for opening a transmission control protocol (TCP) connection with a client;
program instructions for receiving a hypertext transfer protocol (HTTP) client request from the client over the open TCP connection;
program instructions for delaying a server response to the HTTP client request until client data becomes available for transmission to the client so as to maintain the open TCP connection;
program instructions for transmitting a server response to the client over the open TCP connection when client data is pending for transmission to the client; and
program instructions for receiving a subsequent HTTP client request from the client promptly upon receipt of the server response by the client so as to maintain an open TCP connection with the client.

18. A computer readable medium having program instructions stored thereon for controlling server side communication with a client as recited in claim 17, further comprising:
program instructions for operating the server to tag each server response transmitted to the client with a server response sequence number; and
program instructions for operating the server to verify that the server response sequence number included with the subsequent HTTP client request matches the server response sequence number tagged to the most recently transmitted server response.

19. A computer readable medium having program instructions stored thereon for controlling server side communication with a client as recited in claim 18, further comprising:
program instructions for operating the server to retransmit the most recently transmitted server response to the client upon identifying that the server response sequence number included with the subsequent HTTP client request does not match the server response sequence number tagged to the most recently transmitted server response.

20. A computer readable medium having program instructions stored thereon for controlling server side communication with a client as recited in claim 17, wherein the TCP connection is a transient TCP connection.

21. A method for communicating between a client and a server, comprising:
opening a transmission control protocol (TCP) connection between a client and a server;
transmitting a hypertext transfer protocol (HTTP) client request from the client to the server over the open TCP connection;
if client data is not pending at the server upon receipt of the HTTP client request at the server, operating the server to wait for client data to become available before sending a server response to the client so as to maintain the open TCP connection; and
if client data is pending at the server upon receipt of the HTTP client request at the server,
transmitting a server response including the client data from the server to the client over the open TCP connection, wherein the server response is tagged with a server response sequence number,
promptly upon receiving the server response at the client, transmitting a new HTTP client request from the client to the server, wherein the new HTTP client request includes the server response sequence number tagged to a server response most recently received by the client,
upon receiving the new HTTP client request at the server, operating the server to verify that the server response sequence number included with the new HTTP client request matches the server response sequence number tagged to a most recently transmitted server response, and
if the server response sequence number included with the new HTTP client request does not match the server response sequence number tagged to the most recently transmitted server response, operating the server to retransmit the most recently transmitted server response to the client.
